(19) United States
(12) Patent Application Publication
(10) Pub. No.: US 2026/0175605 A1
(43) Pub. Date: Jun. 25, 2026

(54) LIQUID EJECTING APPARATUS AND HEAD UNIT

(71) Applicant: SEIKO EPSON CORPORATION, Tokyo (JP)

(72) Inventors: Kyo HORIE, Okaya (JP); Koichi KASHU, Shiojiri (JP); Toru MATSUYAMA, Matsumoto (JP)

(21) Appl. No.: 19/430,380

(22) Filed: Dec. 23, 2025

(30) Foreign Application Priority Data
Dec. 25, 2024 (JP) 2024-228586

(51) Int. Cl. B41J 29/377; B41J 2/045; B41J 2/14

(52) U.S. Cl. CPC B41J 29/377; B41J 2/04541; B41J 2/0455; B41J 2/04581; B41J 2/04588; B41J 2/14233

(57) ABSTRACT

A liquid ejecting apparatus includes an ejecting portion that is driven by a drive signal to eject a liquid, a circuit substrate on which a drive circuit that generates the drive signal is disposed, a housing that accommodates the circuit substrate, and a screw component that couples the circuit substrate and the housing, in which the circuit substrate has a substrate region in which an opening is not formed, and the screw component is fixed to the circuit substrate in the substrate region.

The present application is based on, and claims priority from JP Application Serial Number 2024-228586, filed December 25, 2024, the disclosure of which is hereby incorporated by reference herein in its entirety.

### BACKGROUND

### 1. Technical Field

The present disclosure relates to a liquid ejecting apparatus and a head unit.

### 2. Related Art

A liquid ejecting apparatus including a drive circuit that generates a drive signal and an ejecting portion that is driven by the drive signal to eject a liquid is known. In such a liquid ejecting apparatus, the drive signal that drives the ejecting portion is a large amplitude signal, and the drive circuit generates heat when generating a drive signal, causing a temperature in the drive circuit. Therefore, various configurations for cooling the drive circuit are proposed in the related art. For example, JP-A-2018-161751 discloses a configuration in which a screw is inserted into an opening provided in a circuit substrate on which a drive circuit is disposed, and the screw couples the circuit substrate to a housing that accommodates the circuit substrate, thereby dissipating the heat emitted from the drive circuit and preventing the temperature increase in the drive circuit.

However, according to the related art, an opening is provided in the circuit substrate in order to fix the screw to the circuit substrate, and thus the opening may function as an antenna. Therefore, according to the related art, the signal from the opening of the circuit substrate that functions as an antenna could be superimposed as noise on various signals generated by the drive circuit such as a drive signal.

### SUMMARY

According to an aspect of the present disclosure, there is provided a liquid ejecting apparatus including an ejecting portion that is driven by a drive signal to eject a liquid, a circuit substrate on which a drive circuit that generates the drive signal is disposed, a housing that accommodates the circuit substrate, and a screw component that couples the circuit substrate and the housing, in which the circuit substrate has a substrate region in which an opening is not formed, and the screw component is fixed to the circuit substrate in the substrate region.

In addition, according to an aspect of the present disclosure, there is provided a head unit including an ejecting portion that is driven by a drive signal to eject a liquid, a circuit substrate on which a drive circuit that generates the drive signal is disposed, and a screw component that couples the circuit substrate and a housing that accommodates the circuit substrate, in which the circuit substrate has a substrate region in which an opening is not formed, and the screw component is fixed to the circuit substrate in the substrate region.

### BRIEF DESCRIPTION OF THE DRAWINGS

FIG. 1 is a block diagram illustrating an example of a configuration of an ink jet printer according to an embodiment of the present disclosure.

FIG. 2 is a perspective view illustrating an example of a schematic internal structure of the ink jet printer.

FIG. 3 is a cross-sectional view illustrating an example of a structure of an ejecting portion.

FIG. 4 is a block diagram illustrating an example of a configuration of a head unit.

FIG. 5 is a timing chart illustrating an example of a signal supplied to the head unit.

FIG. 6 is an explanatory diagram illustrating an example of an individual designation signal.

FIG. 7 is a block diagram illustrating an example of a configuration of a drive signal generation circuit.

FIG. 8 is an exploded perspective view illustrating an example of a structure of a drive signal generation unit and a screw component.

FIG. 9 is a cross-sectional view illustrating an example of a structure of the drive signal generation unit and the screw component.

FIG. 10 is a plan view illustrating an example of a structure of the drive signal generation unit and the screw component.

FIG. 11 is a cross-sectional view illustrating an example of a structure of an ink jet printer according to Comparative Example 1.

FIG. 12 is a cross-sectional view illustrating an example of a structure of an ink jet printer according to Comparative Example 2.

FIG. 13 is a cross-sectional view illustrating an example of a structure of an ink jet printer according to Modification Example 2 of the present disclosure.

FIG. 14 is a plan view illustrating an example of a structure of the ink jet printer according to Modification Example 2 of the present disclosure.

FIG. 15 is a block diagram illustrating an example of a configuration of an ink jet printer according to Modification Example 5 of the present disclosure.

### DESCRIPTION OF EMBODIMENTS

Hereinafter, embodiments for carrying out the present disclosure will be described with reference to the drawings. Meanwhile, a dimension and a scale of each portion are different from actual ones as appropriate in each drawing. The embodiments described below are preferred specific examples of the present disclosure and are thus added with technically preferred various limitations, but the scope of the present disclosure is not limited to such embodiments unless description for limiting the present disclosure is made in the following description.

### A. Embodiment

Hereinafter, a liquid ejecting apparatus will be described using an ink jet printer 1 that ejects ink to form an image on a recording paper PP as an example.

### A. 1. Overview of Ink Jet Printer 1

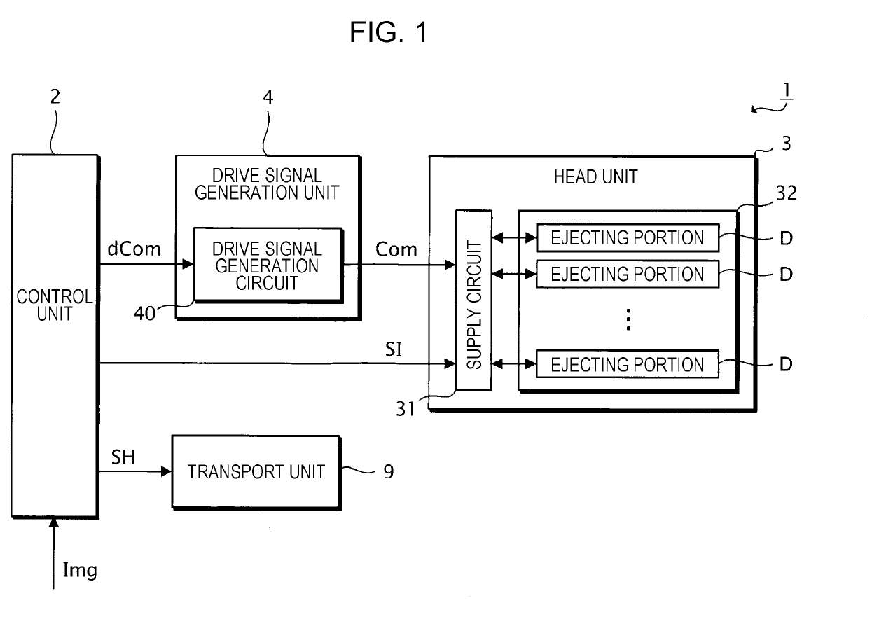

Hereinafter, an example of a configuration of an ink jet printer 1 according to the present embodiment will be described with reference to FIGS. 1 to 3.

FIG. 1 is a functional block diagram illustrating an example of a configuration of an ink jet printer 1.

As illustrated in FIG. 1, the ink jet printer 1 is supplied with print data Img indicating an image to be formed by the ink jet printer 1 from a host computer such as a personal computer or a digital camera. The ink jet printer 1 executes a printing process of forming the image, which is indicated by the print data Img supplied from the host computer, on the recording paper PP.

As illustrated in FIG. 1, the ink jet printer 1 includes a control unit 2 that controls each portion of the ink jet printer 1, a head unit 3 provided with an ejecting portion D that ejects ink on the recording paper PP, a drive signal generation unit 4 provided with a drive signal generation circuit 40 that generates a drive signal Com for driving the ejecting portion D, and a transport unit 9 for transporting the head unit 3 and the recording paper PP.

In the present embodiment, the ink jet printer 1 is an example of a “liquid ejecting apparatus”, ink is an example of a “liquid”, and the drive signal generation circuit 40 is an example of a “drive circuit”.

In the present embodiment, it is assumed that the ink jet printer 1 includes one or a plurality of head units 3. Specifically, in the present embodiment, as an example, it is assumed that the ink jet printer 1 includes four head units 3. In the following, for convenience of description, as illustrated in FIG. 1, the description may focus on one of the four head units 3.

In addition, in the present embodiment, as an example, it is assumed that the drive signal generation unit 4 includes one or a plurality of drive signal generation circuits 40 corresponding to one head unit 3. Specifically, in the present embodiment, it is assumed that the drive signal generation unit 4 includes one drive signal generation circuit 40 corresponding to one head unit 3. That is, in the present embodiment, it is assumed that the drive signal generation unit 4 includes four drive signal generation circuits 40 corresponding to four head units 3. Meanwhile, the present disclosure is not limited to such an aspect. The drive signal generation unit 4 may include two drive signal generation circuits 40 corresponding to one head unit 3, or may include three or more drive signal generation circuits 40 corresponding to one head unit 3. In the following, for convenience of description, as illustrated in FIG. 1, the present embodiment may be described focusing on one drive signal generation circuit 40 among the four drive signal generation circuits 40.

The control unit 2 is configured to include a control circuit (not illustrated) and a memory circuit (not illustrated).

The memory circuit includes a volatile memory such as a random access memory (RAM) and a non-volatile memory such as a read only memory (ROM), an electrically erasable programmable read-only memory (EEPROM), or a programmable ROM (PROM), and stores various information such as a control program of the ink jet printer 1.

The control circuit includes one or a plurality of central processing units (CPU). However, the control circuit may include a programmable logic device such as a field-programmable gate array (FPGA) instead of the CPU or in addition to the CPU. The control circuit executes a control program of the ink jet printer 1 stored in the memory circuit and operates in accordance with the control program to control each portion of the ink jet printer 1. Specifically, the control circuit generates signals for controlling the operations of each portion of the ink jet printer 1, such as a designation signal SI, a waveform designation signal dCom, and a transport control signal SH.

Here, the waveform designation signal dCom is a digital signal for defining a waveform of the drive signal Com. The drive signal Com is an analog signal for driving the ejecting portion D. The designation signal SI is a digital signal designating the type of operation of the ejecting portion D. Specifically, the designation signal SI designates whether the drive signal Com is supplied to the ejecting portion D, and thus designates the type of operation of the ejecting portion D such as the presence or absence of ink ejecting from the ejecting portion D. The transport control signal SH is a signal for controlling the transport unit 9.

When the printing process is executed, the control unit 2 generates a signal for controlling the head unit 3, such as the designation signal SI, based on the print data Img. In addition, the control unit 2 generates a signal for controlling the drive signal generation unit 4, such as the waveform designation signal dCom, when the printing process is executed. Further, when the printing process is executed, the control unit 2 generates a signal for controlling the transport unit 9 such as the transport control signal SH. As a result, in the printing process, the control unit 2 controls the transport unit 9 to move the head unit 3 and the recording paper PP, adjusts the presence or absence of ink ejecting from the ejecting portion D, the ink ejecting timing, and the like, and controls each portion of the ink jet printer 1 so that an image corresponding to the print data Img is formed on the recording paper PP.

As illustrated in FIG. 1, the head unit 3 includes a supply circuit 31 and a head portion 32.

The head portion 32 is provided with M ejecting portions D. Here, a value M is a natural number that satisfies “M ≥ 1”. In the following, among the M ejecting portions D provided in the head portion 32, the m-th ejecting portion D may be referred to as an ejecting portion D[m]. In this case, the variable m is a natural number that satisfies "1 ≤ m ≤ M". In addition, in the following, when a component, signal, or the like of the ink jet printer 1 corresponds to the ejecting portion D[m] among the M ejecting portions D, a subscript [m] may be added to a reference sign for representing the component, signal, or the like.

The supply circuit 31 switches whether to supply the drive signal Com to the ejecting portion D[m] based on the designation signal SI. In the following, among the drive signals Com, the drive signal Com supplied to the ejecting portion D[m] may be referred to as a supply drive signal Vin[m].

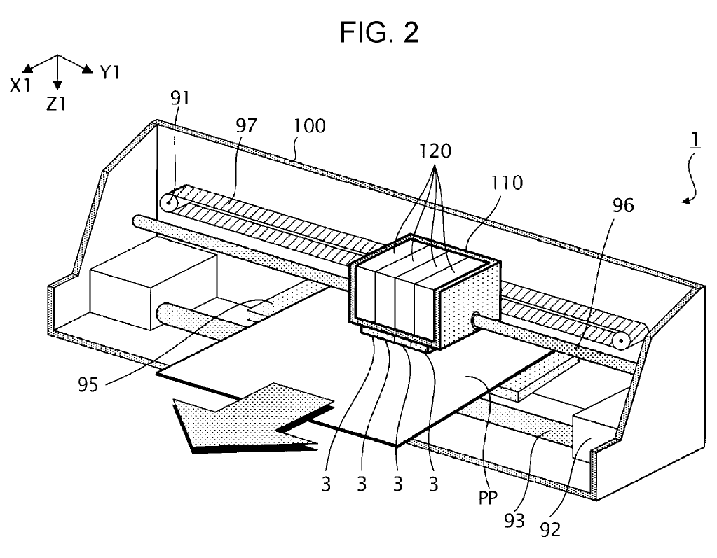

FIG. 2 is a perspective view illustrating an example of the schematic internal structure of the ink jet printer 1.

As illustrated in FIG. 2, in the present embodiment, it is assumed that the ink jet printer 1 is a serial printer. Specifically, when executing the printing process, the ink jet printer 1 forms an image corresponding to the print data Img on the recording paper PP by ejecting ink from the head unit 3 while moving the head unit 3 in a Y1 direction, which intersects an X1 direction, or in a Y2 direction, which is opposite to the Y1 direction, while transporting the recording paper PP in the X1 direction.

In the following, an X1 direction and an X2 direction opposite to the X1 direction are collectively referred to as an “X-axis direction”, a Y1 direction that intersects the X-axis direction and a Y2 direction opposite to the Y1 direction are collectively referred to as a “Y-axis direction”, and a Z1 direction that intersects the X-axis direction and the Y-axis direction and a Z2 direction opposite to the Z1 direction are collectively referred to as a “Z-axis direction”. In the present embodiment, as an example, a description will be made by assuming that the X-axis direction, the Y-axis direction, and the Z-axis direction are orthogonal to each other. Meanwhile, the present disclosure is not limited to such an aspect. The X-axis direction, the Y-axis direction, and the Z-axis direction may intersect each other. In the present embodiment, the Z1 direction is a direction in which the ink is ejected from the ejecting portion D[m].

As illustrated in FIG. 2, the ink jet printer 1 according to the present embodiment is provided with a housing 100 and a carriage 110 that can move back and forth in the housing 100 in the Y-axis direction.

As illustrated in FIG. 2, in the present embodiment, it is assumed that the carriage 110 is mounted with four ink cartridges 120 corresponding one-to-one to four color inks of cyan, magenta, yellow, and black. In addition, in the present embodiment, as described above, it is assumed that the carriage 110 is mounted with four head units 3 corresponding one-to-one to the four ink cartridges 120. Each ejecting portion D[m] receives the ink supplied from the ink cartridge 120 corresponding to the head unit 3 provided with the ejecting portion D[m]. As a result, each ejecting portion D[m] can fill the inside with the supplied ink and eject the ink filled inside the ejecting portion D[m] from the nozzle N provided in the ejecting portion D[m]. The ink cartridge 120 may be provided outside the carriage 110.

In addition, as described above, the ink jet printer 1 according to the present embodiment is provided with the transport unit 9. As illustrated in FIG. 2, the transport unit 9 includes a carriage transport motor 91, a medium transport motor 92, a medium transport mechanism 93, a platen 95, a carriage guide shaft 96, and a belt 97. The carriage transport motor 91 drives the belt 97 based on the transport control signal SH. The belt 97 transports the carriage 110 in the Y-axis direction based on the driving of the carriage transport motor 91. The carriage guide shaft 96 supports the carriage 110 to move back and forth in the Y-axis direction. The medium transport motor 92 drives the medium transport mechanism 93 based on the transport control signal SH. The medium transport mechanism 93 transports the recording paper PP in the X1 direction by rotating based on the driving of the medium transport motor 92. The platen 95 is provided in the Z1 direction of the carriage 110 and supports the recording paper PP transported by the medium transport mechanism 93. Therefore, when the printing process is executed, the transport unit 9 uses the carriage transport motor 91 to move the head unit 3 and the carriage 110 back and forth in the Y-axis direction along the carriage guide shaft 96, and uses the medium transport motor 92 to transport the recording paper PP on the platen 95 in the X1 direction, thereby changing the relative position of the recording paper PP with respect to the head unit 3 and enabling ink to land on the entire recording paper PP.

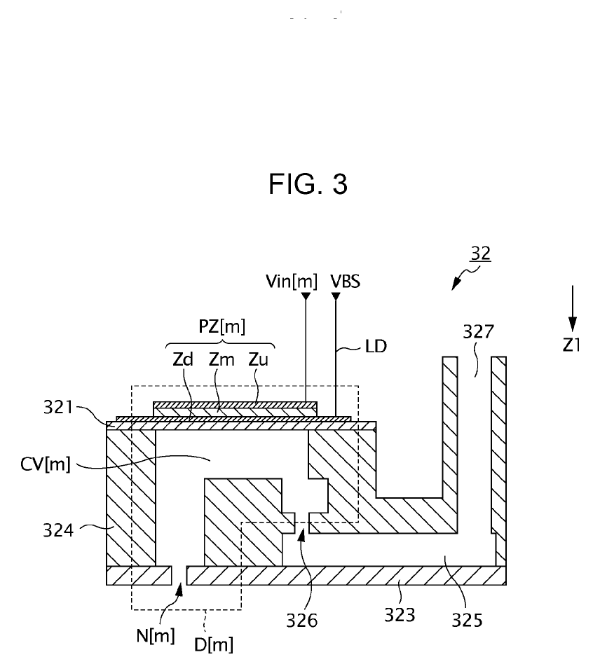

FIG. 3 is a schematic partial cross-sectional view of the head portion 32 in which the head portion 32 is cut to include the ejecting portion D[m].

As illustrated in FIG. 3, the ejecting portion D[m] is provided with the piezoelectric element PZ[m], a cavity CV[m] filled with the ink inside, a nozzle N[m] that communicates with the cavity CV[m], and a vibrating plate 321. The ejecting portion D[m] ejects the ink in the cavity CV[m] from the nozzle N[m] by driving the piezoelectric element PZ[m] by the supply drive signal Vin[m]. The cavity CV[m] is a space partitioned by a cavity plate 324, a nozzle plate 323 in which the nozzles N[m] are formed, and the vibrating plate 321. The cavity CV[m] communicates with a reservoir 325 via an ink supply port 326. The reservoir 325 communicates with the ink cartridge 120 corresponding to the ejecting portion D[m] via an ink intake port 327. The piezoelectric element PZ[m] includes an upper electrode Zu[m], a lower electrode Zd[m], and a piezoelectric body Zm[m] provided between the upper electrode Zu[m] and the lower electrode Zd[m]. The lower electrode Zd[m] is electrically coupled to a power supply line LD set to a predetermined potential VBS. When the supply drive signal Vin[m] is supplied to the upper electrode Zu[m] and a voltage is applied between the upper electrode Zu[m] and the lower electrode Zd[m], the piezoelectric element PZ[m] is displaced in the Z1 direction and the Z2 direction in accordance with the applied voltage. As a result, the piezoelectric element PZ[m] vibrates. The lower electrode Zd[m] is joined to the vibrating plate 321. Therefore, when the piezoelectric element PZ[m] is driven by the supply drive signal Vin[m] and vibrates, the vibrating plate 321 also vibrates. The vibration of the vibrating plate 321 changes the volume of the cavity CV[m] and the pressure inside the cavity CV[m], and the ink filled inside the cavity CV[m] is ejected from the nozzle N[m].

### A. 2. Configuration and Operation of Head Unit 3

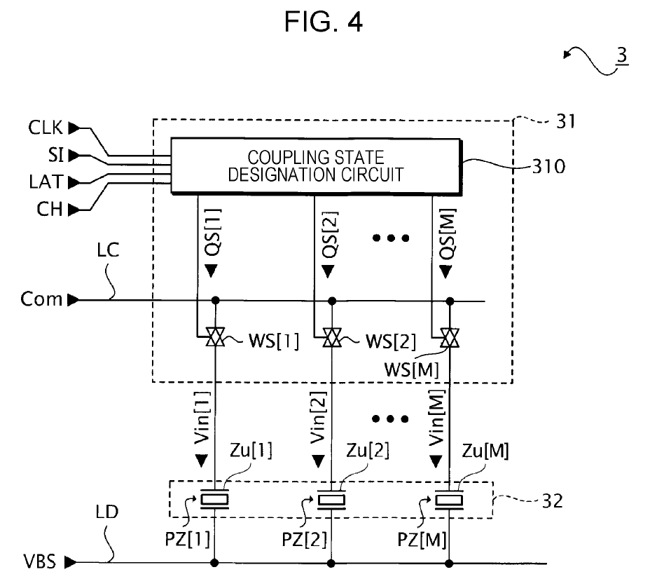

Hereinafter, an example of the configuration and operation of the head unit 3 will be described with reference to FIGS. 4 to 6.

FIG. 4 is a block diagram illustrating an example of a configuration of the head unit 3.

As illustrated in FIG. 4, the head unit 3 includes a supply circuit 31 and a head portion 32. In addition, the head unit 3 includes a wiring LC to which the drive signal Com is supplied from the drive signal generation unit 4.

As illustrated in FIG. 4, the supply circuit 31 is provided with M switches WS[1] to WS[M] that correspond one-to-one to the M ejecting portions D[1] to D[M], and a coupling state designation circuit 310 that designates the coupling state of each switch.

The coupling state designation circuit 310 generates a coupling state designation signal QS[m] that designates on or off of the switch WS[m] based on at least a part of the designation signal SI, the latch signal LAT, the change signal CH, and the clock signal CLK supplied from the control unit 2.

The switch WS[m] switches between conduction and non-conduction between the wiring LC and the upper electrode Zu[m] of the piezoelectric element PZ[m] provided on the ejecting portion D[m], based on the coupling state designation signal QS[m]. In the present embodiment, the switch WS[m] is turned on when the coupling state designation signal QS[m] is at a high level, and is turned off when the coupling state designation signal QS[m] is at a low level. When the switch WS[m] is turned on, the drive signal Com supplied to the wiring LC is supplied to the upper electrode Zu[m] of the ejecting portion D[m] as the supply drive signal Vin[m].

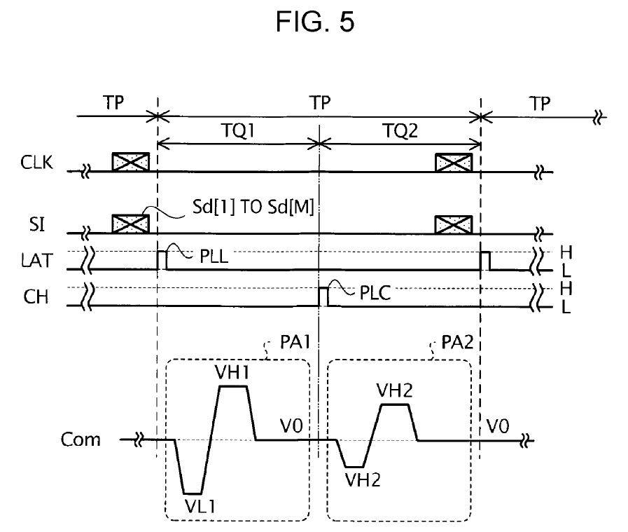

FIG. 5 is a timing chart illustrating an example of various signals such as the drive signal Com supplied to the head unit 3.

As illustrated in FIG. 5, when the ink jet printer 1 executes the printing process, one or a plurality of unit periods TP are set as the operation period of the ink jet printer 1. In the present embodiment, the ink jet printer 1 can drive each ejecting portion D[m] for the printing process in each unit period TP.

As illustrated in FIG. 5, the control unit 2 outputs the latch signal LAT having a pulse PLL. Accordingly, the control unit 2 defines the unit period TP as a period from the rise of the pulse PLL to the rise of the next pulse PLL. In addition, the control unit 2 outputs the change signal CH having a pulse PLC in the unit period TP. The control unit 2 divides the unit period TP into a drive period TQ1 from the rise of the pulse PLL to the rise of the pulse PLC and a drive period TQ2 from the rise of the pulse PLC to the rise of the pulse PLL.

As illustrated in FIG. 5, the designation signal SI includes M individual designation signals Sd[1] to Sd[M] corresponding one-to-one to the M ejecting portions D[1] to D[M]. The individual designation signal Sd[m] designates the aspect of driving the ejecting portion D[m] in each unit period TP when the ink jet printer 1 executes the printing process. The control unit 2 supplies the designation signal SI including the M individual designation signals Sd[1] to Sd[M] to the coupling state designation circuit 310 in synchronization with the clock signal CLK prior to each unit period TP. The coupling state designation circuit 310 generates the coupling state designation signal QS[m] based on the individual designation signal Sd[m] in the unit period TP.

In the present embodiment, it is assumed that the ejecting portion D[m] can form any one of a large dot formed of the ink having the ink amount ξ1, a medium dot formed of the ink having the ink amount ξ2 smaller than the ink amount ξ1, and a small dot formed of the ink having the ink amount ξ3 smaller than the ink amount ξ2, in the unit period TP in which the printing process is executed.

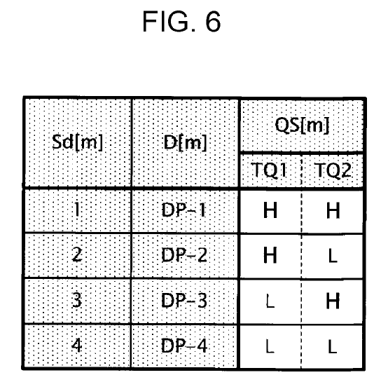

FIG. 6 is an explanatory diagram illustrating an example of an individual designation signal Sd[m].

As illustrated in FIG. 6, in the present embodiment, the individual designation signal Sd[m] can take any one value among four values, a value of “1” that designates the ejecting portion D[m] as a large dot forming ejecting portion DP-1, a value of “2” that designates the ejecting portion D[m] as a medium dot forming ejecting portion DP-2, a value of “3” that designates the ejecting portion D[m] as a small dot forming ejecting portion DP-3, and a value of “4” that designates the ejecting portion D[m] as a dot non-forming ejecting portion DP-4, in the unit period TP in which the printing process is executed.

Here, the large dot forming ejecting portion DP-1 is an ejecting portion D that forms the large dot in the unit period TP. In addition, the medium dot forming ejecting portion DP-2 is an ejecting portion D that forms the medium dot in the unit period TP. In addition, the small dot forming ejecting portion DP-3 is an ejecting portion D that forms the small dot in the unit period TP. In addition, the dot non-forming ejecting portion DP-4 is an ejecting portion D that does not form the dot in the unit period TP.

The description is returned to FIG. 5.

As illustrated in FIG. 5, in the present embodiment, the drive signal Com has a waveform PA1 provided in the drive period TQ1 and a waveform PA2 provided in the drive period TQ2.

Among these, the waveform PA1 is the waveform from a potential V0, through a potential VL1 at a lower potential than the potential V0 and a potential VH1 at a higher potential than the potential V0, and back to the potential V0. When the supply drive signal Vin[m] having the waveform PA1 is supplied to the ejecting portion D[m], the waveform PA1 is determined such that the ink corresponding to an ink amount φ1 is ejected from the ejecting portion D[m]. In addition, the waveform PA2 is a waveform from the potential V0, through a potential VL2 at a lower potential than the potential V0 and a potential VH2 at a higher potential than the potential V0, and back to the potential V0. When the supply drive signal Vin[m] having the waveform PA2 is supplied to the ejecting portion D[m], the waveform PA2 is determined such that the ink corresponding to an ink amount φ2 is ejected from the ejecting portion D[m]. In the present embodiment, it is assumed that the ink amount ξ1 corresponds to the total amount of the ink amount φ1 and the ink amount φ2, the ink amount ξ2 corresponds to the ink amount φ1, and the ink amount ξ3 corresponds to the ink amount φ2.

In addition, in the present embodiment, as an example, it is assumed that when the potential of the supply drive signal Vin[m] supplied to the ejecting portion D[m] is high, the volume of the cavity CV[m] provided in the ejecting portion D[m] is small as compared with a case of low potential. Therefore, when the ejecting portion D[m] is driven by the supply drive signal Vin[m] having the waveform PA1 or the like, the potential of the supply drive signal Vin[m] changes from a low potential to a high potential, and thus the ink in the ejecting portion D[m] is ejected from the nozzle N[m].

As illustrated in FIG. 6, when the individual designation signal Sd[m] indicates the value “1” that designates the ejecting portion D[m] as the large dot forming ejecting portion DP-1 in the unit period TP, the coupling state designation circuit 310 sets the coupling state designation signal QS[m] to a high level in the drive period TQ1 and the drive period TQ2. In this case, the switch WS[m] is turned on in the drive period TQ1 and the drive period TQ2. Therefore, the ejecting portion D[m] is driven by the supply drive signal Vin[m] having the waveform PA1 and the waveform PA2 in the unit period TP, and ejects the ink having an ink amount ξ1 corresponding to a large dot.

In addition, when the individual designation signal Sd[m] indicates the value "2" that designates the ejecting portion D[m] as the medium dot forming ejecting portion DP-2 in the unit period TP, the coupling state designation circuit 310 sets the coupling state designation signal QS[m] to a high level in the drive period TQ1. In this case, the switch WS[m] is turned on in the drive period TQ1. Therefore, the ejecting portion D[m] is driven by the supply drive signal Vin[m] having the waveform PA1 in the unit period TP, and ejects the ink having the ink amount ξ2 corresponding to the medium dot.

In addition, when the individual designation signal Sd[m] indicates the value "3" that designates the ejecting portion D[m] as the small dot forming ejecting portion DP-3 in the unit period TP, the coupling state designation circuit 310 sets the coupling state designation signal QS[m] to a high level in the drive period TQ2. In this case, the switch WS[m] is turned on in the drive period TQ2. Therefore, the ejecting portion D[m] is driven by the supply drive signal Vin[m] having the waveform PA2 in the unit period TP, and ejects the ink having the ink amount ξ3 corresponding to the small dot.

In addition, when the individual designation signal Sd[m] indicates the value “4” that designates the ejecting portion D[m] as the dot non-forming ejecting portion DP-4 in the unit period TP, the coupling state designation circuit 310 sets the coupling state designation signal QS[m] to a low level over the unit period TP. In this case, the switch WS[m] is turned off over the unit period TP. Therefore, the ejecting portion D[m] is not driven by the supply drive signal Vin[m] and does not eject the ink in the unit period TP.

### A. 3. Configuration of Drive Signal Generation Circuit 40

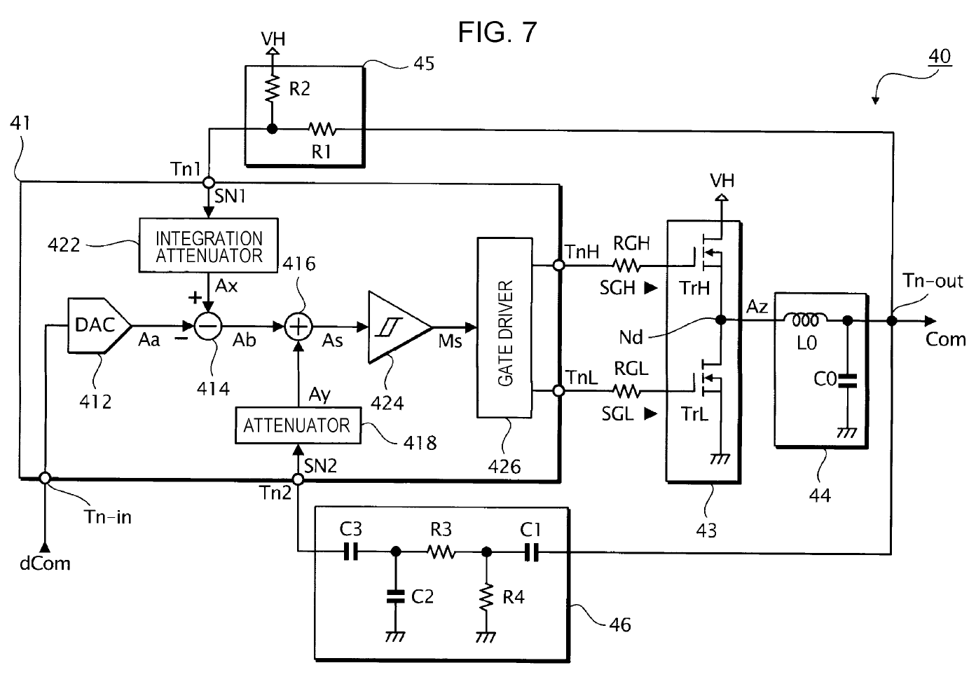

Hereinafter, an example of the configuration of the drive signal generation circuit 40 provided in the drive signal generation unit 4 will be described with reference to FIG. 7.

FIG. 7 is a block diagram illustrating an example of a circuit configuration of the drive signal generation circuit 40.

As illustrated in FIG. 7, the drive signal generation circuit 40 includes an integrated circuit 41, an amplifier circuit 43, a smoothing circuit 44, a pull-up circuit 45, and a filter circuit 46, and generates the drive signal Com based on the waveform designation signal dCom.

The integrated circuit 41 is, for example, a large scale integration (LSI), and generates a gate signal SGH and a gate signal SGL based on the waveform designation signal dCom. The integrated circuit 41 includes an analog conversion circuit 412, a subtractor 414, an adder 416, an attenuator 418, an integration attenuator 422, a comparator 424, and a gate driver 426.

The analog conversion circuit 412 is a digital to analog converter (DAC) and converts the digital waveform designation signal dCom into an analog signal Aa. The voltage amplitude of the signal Aa is, for example, about 0 to 2 volts, and this voltage is amplified by substantially 20 times to become the drive signal Com. That is, the signal Aa is the pre-amplified signal of the drive signal Com.

The integration attenuator 422 outputs a signal Ax obtained by attenuating and then integrating a signal SN1 input to a terminal Tn1 described later.

The subtractor 414 outputs a signal Ab indicating a potential obtained by subtracting the potential of the signal Aa from the potential of the signal Ax.

The attenuator 418 outputs a signal Ay obtained by attenuating the high-frequency component of a signal SN2 input to a terminal Tn2, which will be described later.

The adder 416 outputs a signal As indicating a potential obtained by adding the potential of the signal Ab and the potential of the signal Ay.

The comparator 424 outputs a modulation signal Ms obtained by pulse-modulating the signal As. Specifically, the comparator 424 outputs the modulation signal Ms of which the level shifts to an H level when the voltage is equal to or higher than a threshold voltage Vth1 as the voltage of the signal As rises, and shifts to an L level when the voltage falls below a threshold voltage Vth2 as the voltage of the signal As falls. The threshold voltage Vth1 and the threshold voltage Vth2 are set to have a relationship of "Vth1 > Vth2".

The power supply voltage of the circuit from the analog conversion circuit 412 to the comparator 424 is, for example, a low voltage such as 3.3 volts. On the other hand, the drive signal Com has a large amplitude and may exceed, for example, 40 volts. Therefore, in the integration attenuator 422, the signal SN1 having an amplitude corresponding to the drive signal Com is attenuated, and the amplitude range of the signal Ax matches the amplitude range of the signal in the circuit from the analog conversion circuit 412 to the comparator 424.

In the present embodiment, a digital signal is described as the waveform designation signal dCom as an example, but the waveform designation signal dCom may be any signal that defines a target value for generating the drive signal Com, and for example, the analog signal Aa may be used as the waveform designation signal dCom. When the signal Aa is the waveform designation signal dCom, the integrated circuit 41 may be configured without the analog conversion circuit 412.

The gate driver 426 outputs the gate signal SGH obtained by converting the modulation signal Ms into a specific amplitude to a terminal TnH. Further, the gate driver 426 outputs the gate signal SGL obtained by converting a signal obtained by inverting the logic level of the modulation signal Ms to a specific amplitude to a terminal TnL.

The amplifier circuit 43 includes, for example, a transistor TrH and a transistor TrL, and generates an amplified signal Az which is a signal obtained by amplifying the modulation signal Ms, based on the gate signal SGH and the gate signal SGL output from the integrated circuit 41. In the present embodiment, as an example, it is assumed that the transistor TrH and the transistor TrL are N-channel type electric field effect transistors.

The gate signal SGH output from the gate driver 426 is input to the gate electrode of the transistor TrH via the terminal TnH and a resistor RGH. In addition, the gate signal SGL output from the gate driver 426 is input to the gate electrode of the transistor TrL via the terminal TnL and a resistor RGL. The logic levels of the gate signal SGH and the gate signal SGL are in a mutually exclusive relationship with each other. Here, the “mutually exclusive relationship” means that the signal level of the gate signal SGH supplied to the gate electrode of the transistor TrH and the signal level of the gate signal SGL supplied to the gate electrode of the transistor TrL do not become a high level at the same time, in other words, the transistor TrH and the transistor TrL will not be turned on at the same time. The transistor TrH is turned on when the potential of the gate electrode of the transistor TrH is at a high level, and is turned off when the potential of the gate electrode of the transistor TrH is at a low level. In addition, the transistor TrL is turned on when the potential of the gate electrode of the transistor TrL is at a high level, and is turned off when the potential of the gate electrode of the transistor TrL is at a low level.

The drain electrode of the transistor TrH is electrically coupled to a power supply line set to a power supply potential VH on the high potential side, and the source electrode is electrically coupled to a node Nd. In addition, the source electrode of the transistor TrL is grounded, and the drain electrode is electrically coupled to the node Nd. The source electrode of the transistor TrL may be electrically coupled to the power supply line LD set to the potential VBS.

As described above, the transistor TrH is turned on when the gate signal SGH supplied to the gate electrode is at a high level, and is turned off when the gate signal SGH is at a low level. In addition, the transistor TrL is turned on when the gate signal SGL supplied to the gate electrode is at a high level, and is turned off when the gate signal SGL is at a low level. Therefore, the amplified signal Az obtained by amplifying the modulation signal Ms is output to the node Nd that electrically couples the source electrode of the transistor TrH and the drain electrode of the transistor TrL.

The smoothing circuit 44 is a low pass filter (LPF), and smooths the amplified signal Az to generate the drive signal Com. The smoothing circuit 44 includes an inductor L0 and a capacitor C0. One end of the inductor L0 is electrically coupled to the node Nd, and the other end is electrically coupled to an output terminal Tn-out. One end of the capacitor C0 is electrically coupled to the output terminal Tn-out, and the other end is grounded.

The pull-up circuit 45 feeds back the signal SN1 obtained by pulling up the drive signal Com output to the output terminal Tn-out to the terminal Tn1. The pull-up circuit 45 includes a resistor R1 of which one end is electrically coupled to the output terminal Tn-out and the other end is electrically coupled to the terminal Tn1, and a resistor R2 of which one end is electrically coupled to the terminal Tn1 and the other end is electrically coupled to a power supply line set to the power supply potential VH.

The filter circuit 46 is a band pass filter (BPF), and the filter circuit 46 feeds back the signal SN2 obtained by cutting a DC component from a frequency component in a predetermined band of the drive signal Com to the terminal Tn2. The filter circuit 46 includes a resistor R3, a capacitor C1 of which one end is electrically coupled to the output terminal Tn-out and the other end is electrically coupled to one end of the resistor R3, a resistor R4 of which one end is electrically coupled to one end of the resistor R3 and the other end is grounded, a capacitor C2 of which one end is electrically coupled to the other end of the resistor R3 and the other end is grounded, and a capacitor C3 of which one end is electrically coupled to the other end of the resistor R3 and the other end is electrically coupled to the terminal Tn2. Among these, the capacitor C1 and the resistor R4 function as a high pass filter (HPF) that allows a high-frequency component equal to or higher than a cutoff frequency to pass in the drive signal Com. In addition, the resistor R3 and the capacitor C2 function as a low pass filter (LPF) that allows a low-frequency component equal to or lower than the cutoff frequency to pass in the drive signal Com. In the present embodiment, in the filter circuit 46, the cutoff frequency of the HPF is set to be lower than the cutoff frequency of the LPF. Therefore, the filter circuit 46 passes the frequency component of the drive signal Com in a predetermined band, which is equal to or higher than the cutoff frequency of the HPF and is equal to or lower than the cutoff frequency of the LPF. Further, since the filter circuit 46 includes the capacitor C3, the filter circuit 46 feeds back a signal from which a DC component is cut from a signal of a frequency component in a predetermined band that has passed through the HPF and the LPF of the drive signal Com to the terminal Tn2.

As described above, the drive signal generation circuit 40 generates the drive signal Com by smoothing the amplified signal Az at the node Nd by the smoothing circuit 44. The drive signal Com is integrated and subtracted by the integration attenuator 422 and then fed back to the subtractor 414. Therefore, the self-oscillation occurs at a frequency determined by the delay in the smoothing circuit 44, the delay in the integration attenuator 422, and a feedback transfer function. However, since the delay amount of the feedback path through the terminal Tn1 is large, the frequency of self-oscillation cannot be increased to such an extent that the accuracy of the waveform of the drive signal Com can be sufficiently ensured only by the feedback via the terminal Tn1. On the other hand, in the present embodiment, since a path for feeding back the high-frequency component of the drive signal Com is provided via the terminal Tn2 in addition to the path via the terminal Tn1, the delay of the feedback in the entire drive signal generation circuit 40 can be reduced. That is, in the present embodiment, since the frequency of the signal As obtained by adding the signal Ay, which is the high-frequency component of the drive signal Com, to the signal Ab, can be increased as compared with a case in which the path via the terminal Tn2 is not present, the accuracy of the drive signal Com can be ensured sufficiently.

### A. 4. Configuration of Drive Signal Generation Unit 4

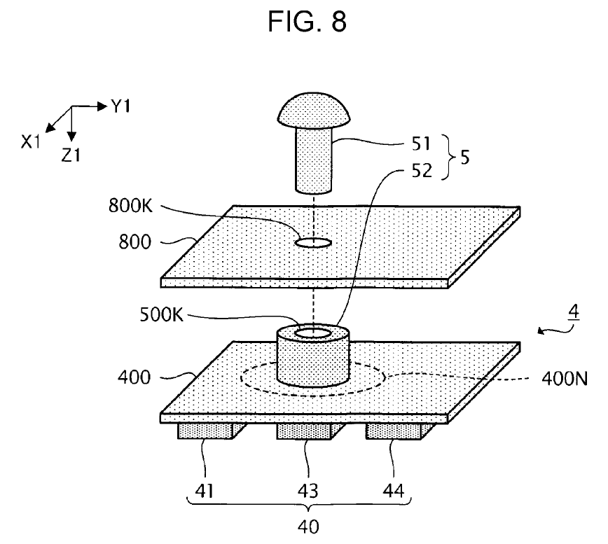

Hereinafter, the drive signal generation unit 4, the screw component 5, and a housing 800 will be described with reference to FIGS. 8 to 10.

FIG. 8 is an exploded perspective view illustrating an example of a configuration including the drive signal generation unit 4, the screw component 5, and the housing 800.

As illustrated in FIG. 8, the ink jet printer 1 includes the drive signal generation unit 4, the screw component 5, and the housing 800.

The housing 800 accommodates the drive signal generation unit 4. In the present embodiment, it is assumed that the housing 100 and the housing 800 are separate from each other and the housing 800 is accommodated inside the housing 100. Meanwhile, the present disclosure is not limited to such an aspect. The housing 800 may be a part of the housing 100.

The drive signal generation unit 4 includes the drive signal generation circuit 40 and a drive circuit substrate 400. The drive circuit substrate 400 is an example of a “circuit substrate” on which the drive signal generation circuit 40 is disposed.

The screw component 5 includes a screw 51 and a nut 52, and fixes the drive signal generation unit 4 to the housing 800. Among these, the screw 51 is inserted into an opening 800K provided in the housing 800 and is fixed to the housing 800. The nut 52 is fixed to the drive circuit substrate 400 in an opening-free region 400N of the drive circuit substrate 400 by, for example, an adhesive. Then, the screw 51 is inserted into a screw hole 500K provided in the nut 52, and the screw 51 and the nut 52 are fastened to each other so that the drive signal generation unit 4 is fixed to the housing 800. Here, the opening-free region 400N (an example of the "substrate region") is a region in which an opening penetrating the drive circuit substrate 400 is not provided. That is, in the present embodiment, the screw component 5 is fixed to the drive circuit substrate 400 without providing an opening in the drive circuit substrate 400.

In FIG. 8, as an example, a case where the normal direction of the drive circuit substrate 400 is the Z1 direction and the extending direction of the screw component 5 is the Z1 direction is illustrated, but the present disclosure is not limited to such an aspect. The normal direction of the drive circuit substrate 400 and the extending direction of the screw component 5 may be any direction.

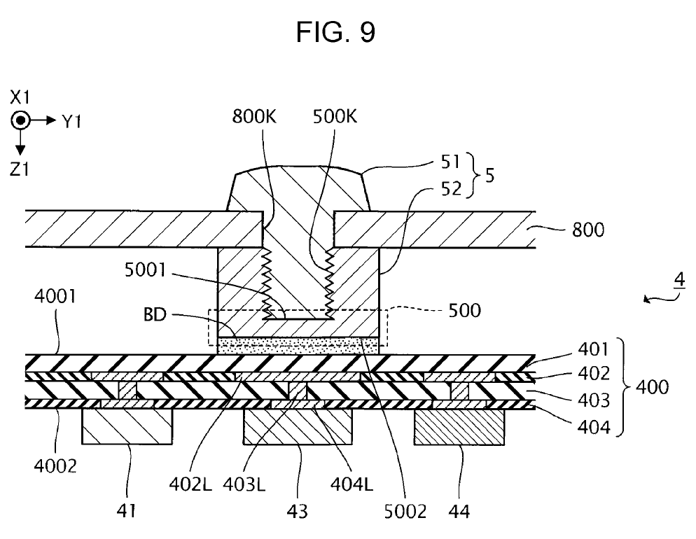

FIG. 9 is a cross-sectional view illustrating an example of a configuration including the drive signal generation unit 4, the screw component 5, and the housing 800.

As illustrated in FIG. 9, in the present embodiment, the nut 52 includes a bottom plate portion 500. The bottom plate portion 500 is a portion that constitutes a bottom surface of the screw hole 500K provided in the nut 52, and is a portion located between the bottom surface of the screw hole 500K and the drive circuit substrate 400 when the nut 52 is fixed to the drive circuit substrate 400. That is, in the present embodiment, the screw hole 500K is a recessed portion provided so as not to penetrate the nut 52.

More specifically, the bottom plate portion 500 has an upper side surface 5001 and a lower side surface 5002. The upper side surface 5001 (an example of a “first surface”) is a portion corresponding to the bottom surface of the screw hole 500K. The lower side surface 5002 (an example of the “second surface”) is a surface on the opposite side of the upper side surface 5001 in the bottom plate portion 500, and is a portion that comes into contact with the drive circuit substrate 400 when the nut 52 is fixed to the drive circuit substrate 400.

As illustrated in FIG. 9, the drive circuit substrate 400 has an upper substrate surface 4001 and a lower substrate surface 4002. The upper substrate surface 4001 (an example of the “first substrate surface”) is a surface to which the nut 52 is fixed. In the present embodiment, it is assumed that the lower side surface 5002 of the nut 52 and the upper substrate surface 4001 of the drive circuit substrate 400 are fixed by an adhesive BD. The lower substrate surface 4002 (an example of the “second substrate surface”) is a surface of the drive circuit substrate 400 on the opposite side of the upper substrate surface 4001, and is a surface provided with the drive signal generation circuit 40 such as the integrated circuit 41, the amplifier circuit 43, and the smoothing circuit 44.

In the present embodiment, it is assumed that the drive circuit substrate 400 is a multilayer substrate including a protective layer 401, a wiring layer 402, an insulating layer 403, and a surface layer 404 between the upper substrate surface 4001 and the lower substrate surface 4002.

The protective layer 401 is a layer including the upper substrate surface 4001, and is made of an insulating material.

The wiring layer 402 is a layer provided with a wiring 402L, and is provided between the protective layer 401 and the lower substrate surface 4002. The wiring 402L is made of a conductive material. The portion of the wiring layer 402 other than the wiring 402L is made of an insulating material.

The insulating layer 403 is a layer provided with a wiring 403L, and is provided between the wiring layer 402 and the lower substrate surface 4002. The wiring 403L is made of a conductive material. The portion of the insulating layer 403 other than the wiring 403L is made of an insulating material.

The surface layer 404 is a layer including the lower substrate surface 4002, and the wiring 404L is provided. The wiring 404L is made of a conductive material. The portion of the surface layer 404 other than the wiring 404L is a resist made of an insulating material.

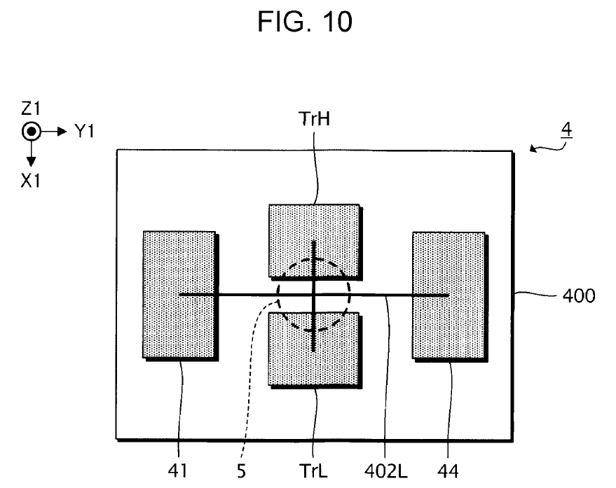

FIG. 10 is a plan view of the drive signal generation unit 4 when viewed in the Z2 direction.

As illustrated in FIG. 10, in the present embodiment, when the drive signal generation unit 4 is viewed in plan view in the Z2 direction, the screw component 5 is provided at a position overlapping the transistor TrH and the transistor TrL and between the transistor TrH and the transistor TrL. In addition, in the present embodiment, when the drive signal generation unit 4 is viewed in plan view in the Z2 direction, the screw component 5 is disposed at a position overlapping the wiring 402L. Furthermore, in the present embodiment, when the drive signal generation unit 4 is viewed in plan view in the Z2 direction, the drive signal generation circuit 40 and the screw component 5 are provided so that the screw component 5, the wiring 402L, and the transistor TrH overlap each other, and the screw component 5, the wiring 402L, and the transistor TrL overlap each other.

In the present embodiment, the transistor TrH is an example of a "first electronic component", and the transistor TrL is an example of a "second electronic component".

### A. 5. Comparative Example

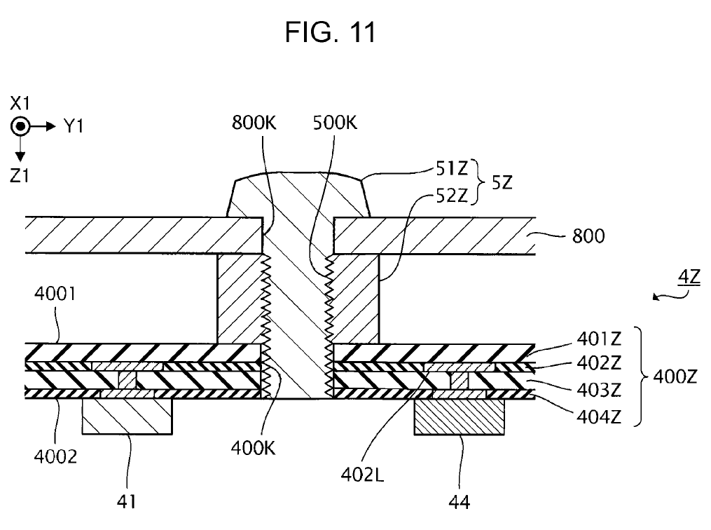

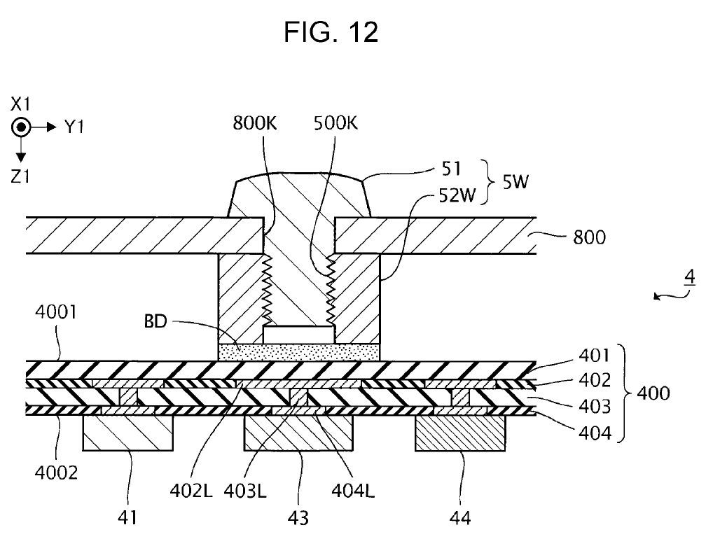

Hereinafter, in order to clarify the effect of the present embodiment, an ink jet printer according to a comparative example will be described with reference to FIGS. 11 and 12.

FIG. 11 is a cross-sectional view illustrating an example of a configuration of an ink jet printer according to Comparative Example 1.

As illustrated in FIG. 11, the ink jet printer according to Comparative Example 1 is configured in the same manner as the ink jet printer 1 according to the embodiment, except that a drive signal generation unit 4Z is provided instead of the drive signal generation unit 4 and a screw component 5Z is provided instead of the screw component 5.

The drive signal generation unit 4Z is different from the drive signal generation unit 4 according to the embodiment in that a drive circuit substrate 400Z is provided instead of the drive circuit substrate 400. The drive circuit substrate 400Z includes a protective layer 401Z, a wiring layer 402Z, a wiring layer 403Z, and a surface layer 404Z. The protective layer 401Z is different from the protective layer 401 according to the embodiment in that an opening 400K is provided. The wiring layer 402Z is different from the wiring layer 402 according to the embodiment in that the opening 400K is provided. The wiring layer 403Z is different from the insulating layer 403 according to the embodiment in that the opening 400K is provided. The surface layer 404Z is different from the surface layer 404 according to the embodiment in that the opening 400K is provided. That is, the drive circuit substrate 400Z is different from the drive circuit substrate 400 according to the embodiment in that the opening 400K penetrating the drive circuit substrate 400Z in the Z-axis direction is provided.

The screw component 5Z includes a screw 51Z and a nut 52Z.

The nut 52Z is different from the nut 52 according to the embodiment in that the bottom plate portion 500 is not provided and the screw hole 500K is provided to penetrate the nut 52Z in the Z-axis direction.

The screw 51Z is inserted into the opening 400K in addition to the screw hole 500K, and is fixed to the nut 52 and the drive circuit substrate 400Z.

As described above, according to Comparative Example 1, the opening 400K is provided in the drive circuit substrate 400Z. Therefore, according to Comparative Example 1, the opening 400K functions as an antenna, and there is a possibility that a signal from the antenna is superimposed on the drive signal Com as noise.

On the other hand, according to the present embodiment, the screw component 5 is fixed to the upper substrate surface 4001 of the drive circuit substrate 400 without providing an opening in the drive circuit substrate 400, and thus, the possibility that the drive circuit substrate 400 functions as an antenna can be reduced as compared with Comparative Example 1. Therefore, according to the present embodiment, as compared with Comparative Example 1, the possibility that noise is superimposed on the drive signal Com can be reduced, and a high-quality image can be formed by the printing process using the drive signal Com having a desired waveform.

FIG. 12 is a cross-sectional view illustrating an example of a configuration of an ink jet printer according to Comparative Example 2.

As illustrated in FIG. 12, the ink jet printer according to Comparative Example 2 is configured in the same manner as the ink jet printer 1 according to the embodiment, except that a screw component 5W is provided instead of the screw component 5.

The screw component 5W includes a screw 51 and a nut 52W.

The nut 52W is different from the nut 52 according to the embodiment in that the bottom plate portion 500 is not provided and the screw hole 500K is provided to penetrate the nut 52W in the Z-axis direction. The nut 52W is inserted into the screw hole 500K and fixed to the nut 52W.

As described above, according to Comparative Example 2, the nut 52W does not include the bottom plate portion 500, and the screw hole 500K penetrates the nut 52W in the Z-axis direction. Therefore, according to Comparative Example 2, the adhesive BD is allowed to penetrate the screw hole 500K, and there is a possibility that the screw 51 may be poorly fastened to the nut 52W.

On the other hand, according to the present embodiment, since the nut 52 includes the bottom plate portion 500, the penetration of the adhesive BD into the screw hole 500K can be prevented. Therefore, according to the present embodiment, the possibility that the nut 52 and the screw 51 are poorly fastened can be reduced as compared with Comparative Example 2.

### A. 6. Summary of Embodiment

As described above, according to the present embodiment, the screw component 5 is fixed to the drive circuit substrate 400 without providing an opening in the drive circuit substrate 400, and thus it is possible to reduce the possibility that the drive circuit substrate 400 functions as an antenna, and a high-quality image can be formed in the printing process.

Further, according to the present embodiment, since the nut 52 includes the bottom plate portion 500, the penetration of the adhesive BD into the screw hole 500K can be prevented, and the possibility that the nut 52 and the screw 51 are poorly fastened can be reduced.

Further, according to the present embodiment, since the screw component 5 is provided at a position overlapping the transistor TrH and the transistor TrL when the drive signal generation unit 4 and the screw component 5 are viewed in plan view in the Z2 direction, the heat emitted from the transistor TrH and the transistor TrL can be dissipated to the housing 800 via the screw component 5. Therefore, according to the present embodiment, it is possible to prevent the temperature increase of the transistor TrH and the transistor TrL, and the distortion of the waveform of the drive signal Com due to the high temperature of the transistor TrH and the transistor TrL can be prevented.

Further, according to the present embodiment, since the screw component 5 is fixed to the drive circuit substrate 400 without providing an opening in the drive circuit substrate 400, the drive signal generation circuit 40 can be disposed at a position overlapping the screw component 5, and the wiring 402L can be disposed at a position overlapping the screw component 5 when the drive signal generation unit 4 and the screw component 5 are viewed in plan view in the Z2 direction. That is, according to the present embodiment, as compared with the aspect in which the opening 400K is provided in the drive circuit substrate 400Z as in Comparative Example 1, the degree of freedom in the disposition of the drive signal generation circuit 40 and the degree of freedom in the disposition of the wiring 402L in the wiring layer 402 can be increased. Therefore, according to the present embodiment, the drive signal generation unit 4 can be miniaturized as compared with Comparative Example 1, and the ink jet printer 1 can be further miniaturized.

### B. Modification Example

Each embodiment above can be variously modified. A specific aspect of the modification will be described below. Two or more aspects selected in any manner from the following examples can be combined with each other as appropriate within a range not inconsistent with each other. In addition, in the modification examples described below, elements having the same actions and functions as those of the embodiment will be given the reference signs used in the description above, and each detailed description thereof will be omitted as appropriate.

### B. 1. Modification Example 1

In the above-described embodiment, an aspect in which the transistor TrH and the transistor TrL are disposed at a position overlapping the screw component 5 when the drive signal generation unit 4 and the screw component 5 are viewed in plan view in the Z2 direction has been described as an example, but the present disclosure is not limited to such an aspect. For example, when the drive signal generation unit 4 and the screw component 5 are viewed in plan view in the Z2 direction, the smoothing circuit 44 may be disposed at a position overlapping the screw component 5. In addition, when the drive signal generation unit 4 and the screw component 5 are viewed in plan view in the Z2 direction, one or two or more electronic components included in the drive signal generation circuit 40 may be disposed at a position overlapping the screw component 5.

Also in Modification Example 1, the heat emitted from the electronic components constituting the drive signal generation circuit 40 can be dissipated to the housing 800 via the screw component 5.

### B. 2. Modification Example 2

In the above-described embodiment and Modification Example 1, an aspect in which the drive signal generation circuit 40 is disposed at a position overlapping the screw component 5 when the drive signal generation unit 4 and the screw component 5 are viewed in plan view in the Z2 direction has been described as an example, but the present disclosure is not limited to such an aspect. For example, when the drive signal generation unit 4 and the screw component 5 are viewed in plan view in the Z2 direction, the drive signal generation circuit 40 may be disposed at a position that does not overlap the screw component 5.

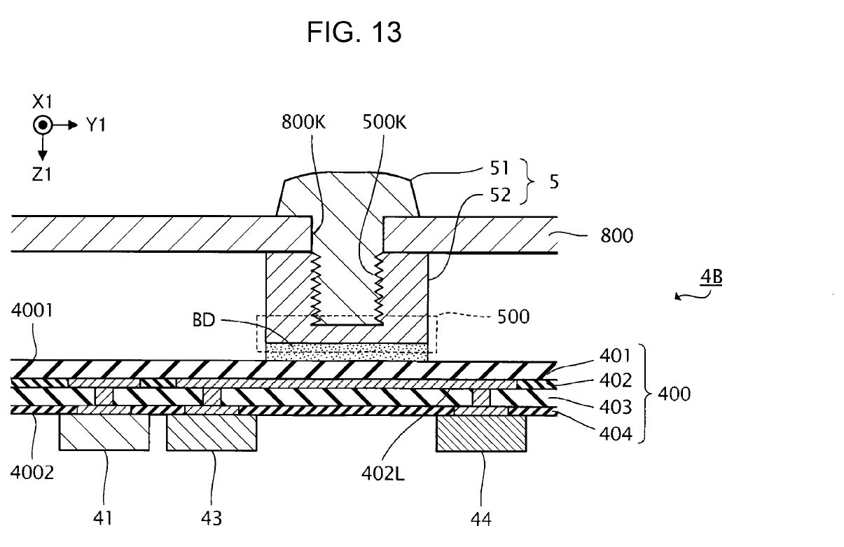

FIG. 13 is a cross-sectional view illustrating an example of a configuration of an ink jet printer according to Modification Example 2.

As illustrated in FIG. 13, the ink jet printer according to Modification Example 2 is configured in the same manner as the ink jet printer 1 according to the embodiment, except that a drive signal generation unit 4B is provided instead of the drive signal generation unit 4. The drive signal generation unit 4B is configured in the same manner as the drive signal generation unit 4 according to the embodiment, except that the drive signal generation circuit 40 is disposed at a position that does not overlap the screw component 5 when the drive signal generation unit 4B and the screw component 5 are viewed in plan view in the Z2 direction.

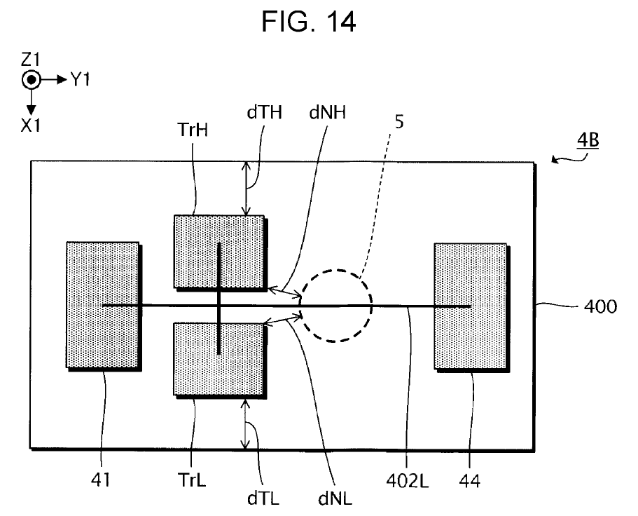

FIG. 14 is a plan view of the drive signal generation unit 4B according to Modification Example 2 when viewed in the Z2 direction.

As illustrated in FIG. 14, when the drive signal generation unit 4B and the screw component 5 are viewed in plan view in the Z2 direction, the screw component 5 is disposed at a position that does not overlap the drive signal generation circuit 40. In addition, when the drive signal generation unit 4B and the screw component 5 are viewed in plan view in the Z2 direction, the screw component 5 is disposed at a position overlapping the wiring 402L.

When the drive signal generation unit 4B and the screw component 5 are viewed in plan view in the Z2 direction, the screw component 5 is provided in the vicinity of the transistor TrH and the transistor TrL. More specifically, in Modification Example 2, when the drive signal generation unit 4B and the screw component 5 are viewed in plan view in the Z2 direction, the transistor TrH and the screw component 5 are provided such that the shortest distance dNH from the transistor TrH to the screw component 5 is shorter than the shortest distance dTH from the transistor TrH to the outer periphery of the drive circuit substrate 400. In addition, when the drive signal generation unit 4B and the screw component 5 are viewed in plan view in the Z2 direction, the transistor TrH and the screw component 5 are provided such that the shortest distance dNL from the transistor TrL to the screw component 5 is shorter than the shortest distance dTL from the transistor TrL to the outer periphery of the drive circuit substrate 400.

Also in Modification Example 2, the heat emitted from the transistor TrH and the transistor TrL can be dissipated to the housing 800 via the screw component 5.

### B. 3. Modification Example 3

In the above-described embodiment and Modification Examples 1 and 2, the aspect in which the wiring 402L is disposed at a position overlapping the screw component 5 when the drive signal generation unit 4 and the screw component 5 are viewed in plan view in the Z2 direction has been described as an example, but the present disclosure is not limited to such an aspect. For example, when the drive signal generation unit 4 and the screw component 5 are viewed in plan view in the Z2 direction, the wiring 402L may be disposed at a position that does not overlap the screw component 5.

### B. 4. Modification Example 4

In the above-described embodiment and Modification Examples 1 to 3, it is assumed that the ink jet printer 1 is used as a serial printer, but the present disclosure is not limited to such an aspect. The ink jet printer 1 may be a so-called line printer in which a plurality of nozzles N are provided in the head unit 3 to extend wider than the width of the recording paper PP. In this case, the head unit 3 does not move back and forth inside the housing 100, and the relative positional relationship between the head unit 3 and the housing 100 does not change.

### B. 5. Modification Example 5

In the above-described embodiment and Modification Examples 1 to 4, an aspect in which the drive signal generation unit 4 is provided separately from the head unit 3 has been described as an example, but the present disclosure is not limited to such an aspect. The drive signal generation unit 4 may be mounted on the head unit 3. In this case, the ink jet printer 1 including the head unit 3 and the drive signal generation unit 4 is preferably the line printer described in Modification Example 4.

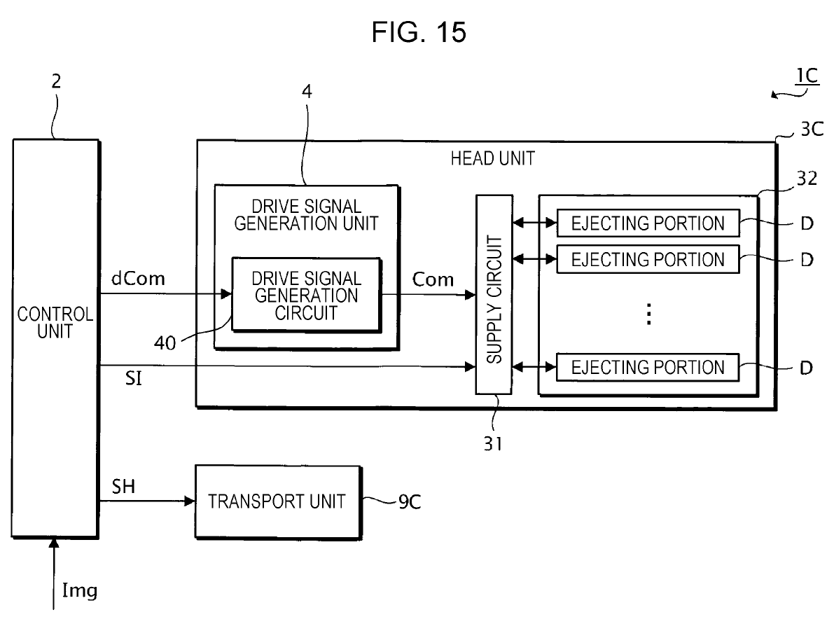

FIG. 15 is a functional block diagram illustrating an example of a configuration of an ink jet printer 1C according to Modification Example 5.

As illustrated in FIG. 15, the ink jet printer 1C is different from the ink jet printer 1 according to the embodiment in that a head unit 3C is provided instead of the head unit 3 and a transport unit 9C is provided instead of the transport unit 9. The head unit 3C is different from the head unit 3 according to the embodiment in that the drive signal generation unit 4 is provided in addition to the supply circuit 31 and the head portion 32. The transport unit 9C transports the recording paper PP, but is different from the transport unit 9 according to the embodiment in that the transport unit 9C does not have a function of transporting the carriage 110 on which the head unit 3 is mounted. Specifically, the transport unit 9C is different from the transport unit 9 according to the embodiment in that the carriage transport motor 91, the carriage guide shaft 96, and the belt 97 are not provided.

Also in Modification Example 5, similarly to the embodiment, since the screw component 5 is fixed to the drive circuit substrate 400 without providing an opening in the drive circuit substrate 400, the possibility that the drive circuit substrate 400 functions as an antenna can be reduced, and a high-quality image can be formed in the printing process.

### C. Appendices

The aspects related to the above description are added below. In order to facilitate understanding of each aspect, in the following, reference signs in the drawings are given in parentheses for convenience, but the present disclosure is not limited to the illustrated aspect.

### Appendix 1

The ink jet printer 1 according to Appendix 1 includes the ejecting portion D that is driven by the drive signal Com to eject ink, the drive circuit substrate 400 on which the drive signal generation circuit 40 that generates the drive signal Com is disposed, the housing 800 that accommodates the drive circuit substrate 400, and the screw component 5 that couples the drive circuit substrate 400 and the housing 800, in which the drive circuit substrate 400 has the opening-free region 400N in which an opening is not formed, and the screw component 5 is fixed to the drive circuit substrate 400 in the opening-free region 400N.

According to Appendix 1, since the drive circuit substrate 400 and the housing 800 are coupled to each other by the screw component 5 without providing an opening such as a screw hole in the drive circuit substrate 400, the generation of noise caused by the opening provided in the drive circuit substrate 400 functioning as an antenna can be prevented, and the deterioration of the printing quality caused by the noise can be prevented.

### Appendix 2

The ink jet printer 1 according to Appendix 2 is the ink jet printer 1 according to Appendix 1, in which the drive signal generation circuit 40 includes a plurality of electronic components including the transistor TrH and the transistor TrL, and the screw component 5 is disposed in the vicinity of the transistor TrH and the transistor TrL in the drive circuit substrate 400 when viewed in a direction perpendicular to the drive circuit substrate 400.

According to the above-described Appendix 2, since the screw component 5 is disposed in the vicinity of the transistor TrH and the transistor TrL, the heat emitted from the transistor TrH and the transistor TrL can be dissipated via the screw component 5.

### Appendix 3

The ink jet printer 1 according to Appendix 3 is the ink jet printer 1 according to Appendix 1 or Appendix 2, in which the drive signal generation circuit 40 includes a plurality of electronic components including the transistor TrH and the transistor TrL, and the screw component 5 is disposed between the transistor TrH and the transistor TrL in the drive circuit substrate 400 when viewed in a direction perpendicular to the drive circuit substrate 400.

According to the above-described Appendix 3, since the screw component 5 is disposed between the transistor TrH and the transistor TrL, the heat emitted from the transistor TrH and the transistor TrL can be dissipated via the screw component 5.

### Appendix 4

The ink jet printer 1 according to Appendix 4 is the ink jet printer 1 according to Appendix 1 to Appendix 3, in which the drive circuit substrate 400 includes the upper substrate surface 4001 on which the screw component 5 is disposed and the lower substrate surface 4002 which is a surface on the opposite side of the upper substrate surface 4001 and on which the drive signal generation circuit 40 is disposed, and the drive signal generation circuit 40 and the screw component 5 overlap each other when viewed in a direction perpendicular to the drive circuit substrate 400.

According to the above-described Appendix 4, since the screw component 5 is fixed to the drive circuit substrate 400 without providing an opening in the drive circuit substrate 400, the drive signal generation circuit 40 can be disposed on the drive circuit substrate 400 without being constrained by the screw component 5.

### Appendix 5

The ink jet printer 1 according to Appendix 5 is the ink jet printer 1 according to Appendix 4, in which the drive circuit substrate 400 is a multilayer substrate including the wiring layer 402 provided between the upper substrate surface 4001 and the lower substrate surface 4002, and the wiring 402L provided on the wiring layer 402, the drive signal generation circuit 40, and the screw component 5 overlap each other when viewed in the direction perpendicular to the upper substrate surface 4001.

According to the above-described Appendix 5, since the screw component 5 is fixed to the drive circuit substrate 400 without providing an opening in the drive circuit substrate 400, the wiring 402L can be disposed in the drive circuit substrate 400 without being constrained by the screw component 5.

### Appendix 6

The ink jet printer 1 according to Appendix 6 is the ink jet printer 1 according to Appendix 1 to Appendix 5, in which the screw component 5 includes the screw 51 fixed to the housing 800 and the nut 52 fixed to the drive circuit substrate 400 in the opening-free region 400N and fastened to the screw 51, the nut 52 includes the screw hole 500K into which the screw 51 is inserted and the bottom plate portion 500 located between the screw hole 500K and the opening-free region 400N when the nut 52 is fixed to the opening-free region 400N, and the bottom plate portion 500 includes the upper side surface 5001 constituting the bottom surface of the screw hole 500K and the lower side surface 5002 which is a surface on the opposite side of the upper side surface 5001 and is fixed to the opening-free region 400N.

According to the above-described Appendix 6, the screw component 5 can be fixed to the drive circuit substrate 400 without providing an opening in the drive circuit substrate 400.

### Appendix 7

The ink jet printer 1 according to Appendix 7 is the ink jet printer 1 according to Appendices 1 to 6, in which the drive circuit substrate 400 includes the upper substrate surface 4001 on which the screw component 5 is disposed and the lower substrate surface 4002 which is a surface on the opposite side of the upper substrate surface 4001 and on which the drive signal generation circuit 40 is disposed, and is a multilayer substrate including the wiring layer 402 provided between the upper substrate surface 4001 and the lower substrate surface 4002, and the wiring 402L provided on the wiring layer 402 and the screw component 5 overlap with each other when viewed in the direction perpendicular to the upper substrate surface 4001.

According to the above-described Appendix 7, since the screw component 5 is fixed to the drive circuit substrate 400 without providing an opening in the drive circuit substrate 400, the wiring 402L can be disposed in the drive circuit substrate 400 without being constrained by the screw component 5.

What is claimed is:

1. A liquid ejecting apparatus comprising:
an ejecting portion that is driven by a drive signal to eject a liquid;
a circuit substrate on which a drive circuit that generates the drive signal is disposed;
a housing that accommodates the circuit substrate; and
a screw component that couples the circuit substrate and the housing, wherein
the circuit substrate has a substrate region in which an opening is not formed, and
the screw component is fixed to the circuit substrate in the substrate region.

2. The liquid ejecting apparatus according to claim 1, wherein
the drive circuit includes a plurality of electronic components including a first electronic component and a second electronic component, and
the screw component is disposed in a vicinity of the first electronic component and the second electronic component on the circuit substrate when viewed in a direction perpendicular to the circuit substrate.

3. The liquid ejecting apparatus according to claim 1, wherein
the drive circuit includes a plurality of electronic components including a first electronic component and a second electronic component, and
the screw component is disposed between the first electronic component and the second electronic component on the circuit substrate when viewed in a direction perpendicular to the circuit substrate.

4. The liquid ejecting apparatus according to claim 1, wherein
the circuit substrate includes
a first substrate surface on which the screw component is disposed, and
a second substrate surface which is a surface on an opposite side of the first substrate surface and on which the drive circuit is disposed, and
the drive circuit and the screw component overlap when viewed in a direction perpendicular to the first substrate surface.

5. The liquid ejecting apparatus according to claim 4, wherein
the circuit substrate is a multilayer substrate including a wiring layer provided between the first substrate surface and the second substrate surface, and
a wiring provided on the wiring layer, the drive circuit, and the screw component overlap when viewed in the direction perpendicular to the first substrate surface.

6. The liquid ejecting apparatus according to claim 1, wherein
the screw component includes
a screw fixed to the housing, and
a nut fixed to the circuit substrate in the substrate region and fastened to the screw,
the nut includes
a screw hole into which the screw is inserted, and
a bottom plate portion that is located between the screw hole and the substrate region when the nut is fixed to the substrate region, and
the bottom plate portion includes
a first surface that constitutes a bottom surface of the screw hole, and
a second surface which is a surface on an opposite side of the first surface and is fixed to the substrate region.

7. The liquid ejecting apparatus according to claim 1, wherein
the circuit substrate is a multilayer substrate including a first substrate surface on which the screw component is disposed, a second substrate surface which is a surface on an opposite side of the first substrate surface and on which the drive circuit is disposed, and a wiring layer provided between the first substrate surface and the second substrate surface, and
a wiring provided on the wiring layer and the screw component overlap when viewed in a direction perpendicular to the first substrate surface.

8. A head unit comprising:
an ejecting portion that is driven by a drive signal to eject a liquid;
a circuit substrate on which a drive circuit that generates the drive signal is disposed; and
a screw component that couples the circuit substrate and a housing that accommodates the circuit substrate, wherein
the circuit substrate has a substrate region in which an opening is not formed, and
the screw component is fixed to the circuit substrate in the substrate region.

9. The head unit according to claim 8, wherein
the drive circuit includes a plurality of electronic components including a first electronic component and a second electronic component, and
the screw component is disposed in a vicinity of the first electronic component and the second electronic component on the circuit substrate when viewed in a direction perpendicular to the circuit substrate.

10. The head unit according to claim 8, wherein
the drive circuit includes a plurality of electronic components including a first electronic component and a second electronic component, and
the screw component is disposed between the first electronic component and the second electronic component on the circuit substrate when viewed in a direction perpendicular to the circuit substrate.

11. The head unit according to claim 8, wherein
the circuit substrate includes
a first substrate surface on which the screw component is disposed, and
a second substrate surface which is a surface on an opposite side of the first substrate surface and on which the drive circuit is disposed, and
the drive circuit and the screw component overlap when viewed in a direction perpendicular to the first substrate surface.

12. The head unit according to claim 11, wherein
the circuit substrate is a multilayer substrate including a wiring layer provided between the first substrate surface and the second substrate surface, and
a wiring provided on the wiring layer, the drive circuit, and the screw component overlap when viewed in the direction perpendicular to the first substrate surface.

13. The head unit according to claim 8, wherein
the screw component includes
a screw fixed to the housing, and
a nut fixed to the circuit substrate in the substrate region and fastened to the screw,
the nut includes
a screw hole into which the screw is inserted, and
a bottom plate portion that is located between the screw hole and the substrate region when the nut is fixed to the substrate region, and
the bottom plate portion includes
a first surface that constitutes a bottom surface of the screw hole, and
a second surface which is a surface on an opposite side of the first surface and is fixed to the substrate region.

14. The head unit according to claim 8, wherein
the circuit substrate is a multilayer substrate including a first substrate surface on which the screw component is disposed, a second substrate surface which is a surface on an opposite side of the first substrate surface and on which the drive circuit is disposed, and a wiring layer provided between the first substrate surface and the second substrate surface, and
a wiring provided on the wiring layer and the screw component overlap when viewed in a direction perpendicular to the first substrate surface.
